(19) United States
(12) Patent Application Publication
(10) Pub. No.: US 2026/0109452 A1
(43) Pub. Date: Apr. 23, 2026

(54) FLIGHT CONTROL SYSTEM AND METHOD FOR AN AIRCRAFT

(71) Applicant: Airbus Operations SAS, TOULOUSE (FR)

(72) Inventors: Simon OUDIN, TOULOUSE (FR); Victor GIBERT, TOULOUSE (FR); Clément FROT, TOULOUSE (FR)

(21) Appl. No.: 19/351,971

(22) Filed: Oct. 7, 2025

(30) Foreign Application Priority Data
Oct. 18, 2024 (FR) FR2411337

(51) Int. Cl. B64C 13/16; G05D 1/652

(52) U.S. Cl. CPC B64C 13/16; G05D 1/652

(57) ABSTRACT

A flight control system with at least one flight control computer for the aircraft designed to control an elevator of the aircraft. During an acceleration phase of the aircraft when it is taxiing on the ground in preparation for take-off, the at least one flight control computer is configured to repeatedly: determine a deflection angle of the elevator, corresponding to a load to be applied to the nose gear of the aircraft such that the load is within a predetermined load range; and control an actuator of the elevator so as to apply the deflection angle to the elevator.

### CROSS-REFERENCES TO RELATED APPLICATIONS

This application claims the benefit of French Patent Application Number FR2411337 filed on Oct. 18, 2024, the entire disclosure of which is incorporated herein by way of reference.

### FIELD OF THE INVENTION

The invention relates to the field of flight controls for aircraft. During a take-off phase of an aircraft on an airport runway, a pilot of the aircraft initially commands the aircraft to taxi along the runway, accelerating until the aircraft reaches a predetermined speed, called rotation speed. At this rotation speed, the pilot commands a nose-up rotation of the aircraft by acting on a control device in the cockpit, such as, for example, a control stick or a mini control stick. This command causes the deflection of at least one of the elevators of the aircraft. As a result, the nose gear of the aircraft lifts off the ground and the aircraft then runs on its main landing gear in a nose-up position. The nose-up rotation of the aircraft, when the pilot operates the control device, is more or less rapid depending on the load applied by the aircraft to the nose gear due to its weight. This load notably depends on the position of the center of gravity of the aircraft, and therefore in particular on the load of the aircraft (the number and the distribution of passengers, the amount of cargo, etc.), which can vary depending on the flights of the aircraft. The higher this load, the longer it takes to lift the nose gear. When the load applied to the nose gear is very high, the first part of the deflection of the elevator only releases the load on the nose gear that was previously applied by the aircraft. This requires a longer time the higher the load previously applied by the aircraft to the nose gear. Then, a second part of the deflection of the elevator results in the nose gear being lifted and therefore in the aircraft being nose-up. Only this second part of the deflection of the elevator is actually useful for the nose-up rotation of the aircraft. As a result, the response time between an action of the pilot on the control device and the nose-up rotation of the aircraft varies as a function of the load applied by the aircraft to the nose gear. Having consistent rotations irrespective of the load applied by the aircraft to the nose gear would be desirable, in order to improve the take-off performance capabilities of the aircraft and the flight characteristics during the take-off phase.

### SUMMARY OF THE INVENTION

The present invention notably aims to provide a solution to this problem. It relates to a flight control system for an aircraft comprising at least one flight control computer for the aircraft designed to control an elevator of the aircraft. The flight control system is characterized in that the at least one flight control computer is configured to repeatedly implement the following steps, during an acceleration phase of the aircraft when it is taxiing on the ground in preparation for take-off, of:
determining a deflection angle of the elevator, for which deflection angle a load applied by the aircraft to its nose gear is such that said load is within a predetermined load range;
controlling an actuator of the elevator so as to apply said deflection angle to the elevator.

Thus, the flight control system allows the load applied by the aircraft on its nose gear during the acceleration phase in preparation for take-off to be controlled, and therefore particularly when a pilot commands a nose-up rotation of the aircraft. As a result, the response time between an action of the pilot on the control device and the nose-up rotation of the aircraft is substantially independent of the load initially applied by the aircraft to the nose gear, which allows consistent rotations to be provided irrespective of the load initially applied by the aircraft to the nose gear.

In one embodiment, with the elevator forming part of a set of elevators of the aircraft, the flight control computer is configured such that the step of determining the deflection angle of the elevator comprises the following sub-steps of:
estimating a total moment about a pitch axis of the aircraft;
estimating a moment about the pitch axis induced by the elevators of the set of elevators; and
computing the deflection angle of the elevator as a function of the total moment, of the moment induced by the elevators, of said load to be applied to the nose gear, and of a distance between the center of gravity of the aircraft and the nose gear.

In one embodiment, the at least one flight control computer is further configured to acquire a current speed value of the aircraft and to implement the steps of determining the deflection angle of the elevator and of controlling the actuator of the elevator so as to apply said deflection angle to the elevator only if the current speed value is at least equal to a predetermined speed threshold.

In one embodiment, the flight control computer is configured such that the step of determining the deflection angle of the elevator comprises a sub-step of limiting said deflection angle of the elevator between a minimum deflection angle value and a maximum deflection angle value.

The invention also relates to a method for controlling an elevator of an aircraft, the aircraft comprising a flight control system comprising at least one flight control computer for controlling the elevator. The method is characterized in that it comprises the following steps, repeatedly implemented by the at least one flight control computer during an acceleration phase of the aircraft when it is taxiing on the ground in preparation for take-off, of:
determining a deflection angle of the elevator, corresponding to a load applied by the aircraft to its nose gear such that said load is within a predetermined load range;
controlling an actuator of the elevator so as to apply said deflection angle to the elevator.

In one embodiment, with the elevator forming part of a set of elevators of the aircraft, the step of determining the deflection angle of the elevator comprises the following sub-steps of:
estimating a total moment about a pitch axis of the aircraft;
estimating a moment about the pitch axis induced by the elevators of the set of elevators; and
computing the deflection angle of the elevator as a function of the total moment, of the moment induced by the elevators, of said load to be applied to the nose gear, and of a distance between the center of gravity of the aircraft and the nose gear.

In one embodiment, the method further comprises a step of acquiring a current speed value of the aircraft and the steps of determining the deflection angle of the elevator and of controlling the actuator of the elevator so as to apply said deflection angle to the elevator are only implemented if the current speed value is at least equal to a predetermined speed threshold.

In one embodiment, the step of determining the deflection angle of the elevator comprises a sub-step of limiting said deflection angle of the elevator between a minimum deflection angle value and a maximum deflection angle value.

The invention also relates to an aircraft comprising such a flight control system.

### BRIEF DESCRIPTION OF THE DRAWINGS

The invention will be better understood upon reading the following description and with reference to the accompanying figures.

FIG. 1 is a view of an aircraft comprising a flight control system according to one embodiment of the invention.

FIG. 2 schematically illustrates a flight control system according to one embodiment of the invention.

FIG. 3 illustrates a flight control method for an aircraft according to one embodiment of the invention.

### DETAILED DESCRIPTION OF THE PREFERRED EMBODIMENTS

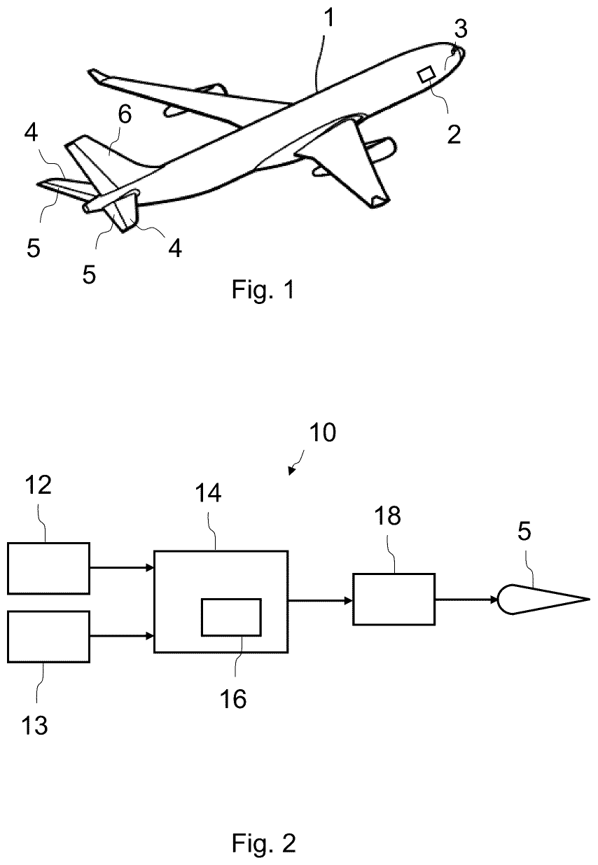

The aircraft 1 shown in FIG. 1 comprises a set of elevators 5, referred to throughout the remainder of the description as “the elevators”. In the example illustrated in the figure, each elevator 5 is hinged relative to a horizontal plane 4 of a rear tail unit of the aircraft. At least one elevator 5 is hinged relative to each horizontal plane 4. In the example illustrated in the figure, the rear tail unit comprises two horizontal planes 4 arranged in the lower part of the tail unit, symmetrically with respect to a vertical fin 6. In the case of other aircraft, one or more horizontal planes can be arranged in the upper part of the vertical fin 6.

The aircraft 1 comprises a flight control system, such as the flight control system 10 illustrated in FIG. 2. This flight control system comprises a set 14 of flight control computers, including at least one flight control computer 16 whose output is connected to an actuator 18 of an elevator 5 forming part of the set of elevators of the aircraft. The input of the flight control computer 16 is also connected to a control device 12 of the aircraft, such as a control stick or a mini control stick installed in a cockpit 3 of the aircraft. The flight control computer 16 is configured to control the actuator 18 of the elevator 5, in particular as a function of control commands received from the control device 12. For the sake of clarity, this description relates to the control of a single actuator 18 of said elevator 5. However, without departing from the scope of the invention, the output of the flight control computer 16 also can be connected to other actuators not shown in the figure, with these other actuators being designed to actuate said elevator 5 and/or other elevators of the set of elevators, not shown in the figure. Thus, the flight control computer 16 is designed to control at least one elevator 5 of the aircraft. Throughout the remainder of the description, the term “elevator” refers to this at least one elevator, i.e., said elevator 5 illustrated in the figure or even any elevator of the set of elevators for which at least one actuator is controlled by the flight control computer 16. The input of the flight control computer 16 is also connected to a set of information sources 13 of the aircraft. The set of computers 14 is installed, for example, in an avionics bay 2 of the aircraft.

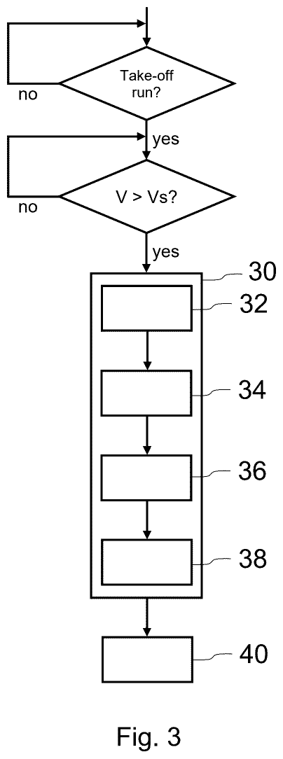

During operation, during a take-off phase of the aircraft on an airport runway, an aircraft pilot activates a thrust lever for the aircraft engines, which controls the thrust of the aircraft engines to enable take-off. The aircraft then taxis down the runway, accelerating. This take-off phase, during which the aircraft accelerates along the runway, is also called “take-off run”. The flight control computer 16 is connected to other avionics computers in the aircraft, from which it receives information indicating that the aircraft is in said take-off run phase. The flight control computer 16 also receives information from the set of information sources 16, for example, an inertial unit or a receiver of a satellite navigation system, concerning the speed V of the aircraft. When the aircraft is in the take-off run phase and, advantageously, its speed is greater than a predetermined speed threshold Vs, the flight control computer 16 implements the steps of the method illustrated in FIG. 3. The predetermined speed threshold Vs is, for example, equal to 80 knots, that is, approximately 148 km/h. In a first step 30, the flight control computer 16 determines a deflection angle of the elevator 5, corresponding to a load F_{z} to be applied to the nose gear of the aircraft, such that said load F_{z} is within a predetermined load range [F_{zmin}; F_{zmax}]. This load range corresponds, for example, to a range of masses [1 tonne; 2.5 tonnes] applied to the nose gear. Even if the flight control computer 16 controls only one elevator, or only some of the elevators of the set of elevators, the deflection angle is determined by considering that the one or more elevators that are not controlled by this flight control computer 16 are also controlled, by other flight control computers, at the same deflection angle. All the elevators of the set of elevators are controlled at the same deflection angle.

Advantageously, the first step 30 comprises the following sub-steps:
a sub-step 32 of estimating a total moment about a pitch axis of the aircraft;
a sub-step 34 of estimating a moment about the pitch axis induced by the elevators; and
a sub-step 36 of computing the deflection angle of the elevator as a function of the total moment, of the moment induced by the elevators, of said load F_{z} to be applied by the aircraft to the nose gear, and of a distance between the center of gravity of the aircraft and the nose gear.

In one embodiment, in sub-step 32, the flight control computer 16 computed an estimate of the total moment M_{TOTAL} about the pitch axis using the following equation:

$${M}_{Total} = {M}_{pitch} + {M}_{Lift} + {M}_{Thrust} + {M}_{Braking} + {M}_{GroundSpoilers}$$

$$in which :$$

$${M}_{Pitch} = Cm \cdot S \cdot l \cdot {P}_{dyn}$$

$${M}_{Lift} = {d}_{MainLanding gear \to CG} \cdot ( m \cdot g - Cz \cdot S \cdot {P}_{dyn} )$$

$${M}_{Thrust} = {d}_{Engine \to CG} \cdot {Force}_{Thrust}$$

$${M}_{Braking} = {d}_{MainLanding gear \to CG} \cdot {Force}_{Breaking}$$

$${M}_{GroundSpoilers} = {Cm}_{{δ}_{GSP}} \cdot {δ}_{GSP} \cdot S \cdot l \cdot {P}_{dyn} + {Cm}_{{δ}_{GSP}} \cdot {δ}_{GSP} \cdot S \cdot {P}_{dyn} \cdot {d}_{CG \to Center of thrust}$$

with:
Cm: being the aerodynamic pitch coefficient;
Cz: being the aerodynamic lift coefficient;
S: being the reference surface area;
l: being the mean aerodynamic chord;
P_{dyn}: being the dynamic pressure;
m: being the mass of the aircraft;
g: being the gravitational constant;
nₓ: being the acceleration along the longitudinal axis of the aircraft fuselage;

$${Force}_{Thrust} = {f}_{1} ( {n}_{x} ) ;$$

$${Force}_{Breaking} = {f}_{2} ( {n}_{x} ) ;$$

f₁(nₓ) is a first function of nₓ and notably of the sign of nₓ;
f₂(nₓ) is a second function of nₓ and notably of the sign of nₓ;
δ_{GSP}: being the deflection of the air brakes, also called ground spoilers;
Cm_{δ}_{_{GSP}}: being the aerodynamic efficiency coefficient related to the deflection of the air brakes (ground spoilers);
d_{MainLanding gear→CG}: being the component, along the longitudinal axis of the aircraft fuselage, of the distance between the main landing gear of the aircraft and the center of gravity of the aircraft;
d_{Engine→CG}: being the component, along the longitudinal axis of the aircraft fuselage, of the distance between the propulsion engines of the aircraft and the center of gravity of the aircraft;
d_{CG→Center of thrust}: being the distance between the center of gravity of the aircraft and the center of thrust.

Within this information, any information where the value is variable (dynamic pressure, acceleration, etc.) is transmitted, for example, to the flight control computer 16 by information sources from the set of information sources 13. Any information where the value is constant is stored, for example, in a memory or a database of the flight control computer 16 or even in a memory or a database of an avionics computer forming part of the set of information sources 13.

In one embodiment, in sub-step 34, the flight control computer 16 computes an estimate of the moment about the pitch axis induced by the elevators 5 using the following equation:

$${M}_{elevators} = m \cdot {δ}_{q} = S \cdot l \cdot {P}_{dyn} \cdot {Cm}_{{δ}_{q}}$$

with:
δ_{q}: being the deflection of the elevators;
Cm_{δ}_{_{q}}: being the aerodynamic efficiency coefficient related to the deflection of the elevators.

In one embodiment, in sub-step 36, the flight control computer 16 computes the deflection angle δ_{q} of the elevator 5 as a function of the total moment Mₜₒₜₐₗ, of the moment Mₑₗₑᵥₐₜₒᵣₛ induced by the elevators, of said load F_{z} to be applied by the aircraft to the nose gear, and of the distance between the center of gravity of the aircraft and the nose gear, using the following equation:

$${δ}_{q} = \frac{{M}_{Total} + Fz \cdot {d}_{{x}_{CG} \to NW}}{{M}_{elevators}}$$

with:
dₓ_{_{CH}}_{→NW}: being the distance between the center of gravity of the aircraft and the nose gear.

Advantageously, the flight control computer 16 computes two deflection angle values for the elevator 5: a minimum deflection angle value δ_{q}_{ₘᵢₙ} and a maximum deflection angle value δ_{q}_{ₘₐₓ}, respectively corresponding to the minimum F_{zmin} and maximum F_{zmax} limits of the predetermined load range [F_{zmin}; F_{zmax}].

These two deflection angle values are computed using, for example, the following equations:

$${δ}_{{q}_{min}} = \frac{{M}_{Total} + {F}_{{z}_{min}} \cdot {d}_{{x}_{CG} \to NW}}{{M}_{elevators}}$$

$${δ}_{{q}_{max}} = \frac{{M}_{Total} + {F}_{{z}_{max}} \cdot {d}_{{x}_{CG} \to NW}}{{M}_{elevators}}$$

These two values delimit a range [δ_{q}_{ₘᵢₙ}; δ_{q}_{ₘₐₓ}] of permissible values of the deflection angle of the elevator 5 in order to obtain a load on the nose gear within the predetermined load range [F_{zmin}; F_{zmax}].

The method further comprises a second step 40, during which the flight control computer 16 controls the actuator 18 of the elevator 5 so as to apply the deflection angle computed in step 30 to the elevator. This thus allows said desired load F_{z} to be applied to the nose gear.

In a particular embodiment, the step 30 further comprises a sub-step 38 of limiting the deflection angle of the elevator previously computed in sub-step 36 between a minimum deflection angle value and a maximum deflection angle value. The minimum deflection angle value is, for example, equal to −5 degrees (nose-up deflection) and the maximum deflection angle value is, for example, equal to 10 degrees (nose-down deflection). This limitation of the deflection angle ensures that the commanded deflection angle of the elevator 5 remains within a range of values that is selected so as to also allow elevator deflection commands commanded by a pilot of the aircraft to affect the aircraft.

As indicated above, the condition for engaging steps 30 and 40 of the method, whereby the speed of the aircraft is greater than a predetermined speed threshold Vs, corresponds to an advantageous embodiment, but it by no means limits the invention. Compliance with this condition notably allows the load applied by the aircraft to the nose gear to be controlled only when it is most useful for the purpose of the nose-up rotation of the aircraft. Furthermore, given that the effect of the deflection of the elevators on the load applied to the nose gear of the aircraft is greater when the aircraft speed is high, implementing steps 30 and 40 of the method for speeds below the predetermined speed threshold Vs could unnecessarily cause significant deflections of the elevators for controlling the load F_{z} on the nose gear of the aircraft.

Implementing steps 30 and 40 of the method allows the load F_{z} applied by the aircraft to its nose gear to be controlled. As a result, the nose-up rotations for different take-off phases of the aircraft are thus consistent. The limit F_{zmax} of the range [F_{zmin}; F_{zmax}], from which the load F_{z} to be applied to the nose gear of the aircraft is selected, is defined such that when the pilot commands a nose-up deflection of the elevators 5, the time required to release the load F_{z} on the nose gear applied by the aircraft is short enough in relation to the operational constraints of take-off. Advantageously, the limit F_{zmin} of the range [F_{zmin}; F_{zmax}] is defined such that the load F_{z} to be applied to the nose gear of the aircraft is sufficient to prevent the aircraft from experiencing an autorotation phenomenon during the take-off run.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A flight control system for an aircraft comprising:
at least one flight control computer for the aircraft configured to control an elevator of the aircraft, wherein the at least one flight control computer is further configured to repeatedly implement, during an acceleration phase of the aircraft when the aircraft is taxiing in preparation for take-off, the following steps:
determining a deflection angle of the elevator, the deflection angle corresponding to a load applied by the aircraft to a nose gear such that the load is within a predetermined load range; and
controlling an actuator of the elevator so as to apply said deflection angle to the elevator.

2. The flight control system as claimed in claim 1, wherein, with the elevator forming a part of a set of elevators of the aircraft,
wherein the step of determining the deflection angle of the elevator comprises the following sub-steps:
estimating a total moment about a pitch axis of the aircraft;
estimating a moment about the pitch axis induced by the elevators of the set of elevators; and
computing the deflection angle of the elevator as a function of the total moment, the moment induced by the elevators of the set of elevators, the load to be applied to the nose gear, and a distance between a center of gravity of the aircraft and the nose gear.

3. The flight control system as claimed in claim 1, wherein the at least one flight control computer is further configured to acquire a current speed value of the aircraft and to implement the steps of determining the deflection angle of the elevator and of controlling the actuator of the elevator so as to apply said deflection angle to the elevator only when the current speed value is at least equal to a predetermined speed threshold.

4. The flight control system as claimed in claim 1, wherein the step of determining the deflection angle of the elevator comprises a sub-step of limiting said deflection angle of the elevator between a minimum deflection angle value and a maximum deflection angle value.

5. A method for controlling an elevator of an aircraft, the aircraft comprising a flight control system comprising at least one flight control computer designed to control the elevator, wherein the method comprises the following steps, repeatedly implemented by the at least one flight control computer during an acceleration phase of the aircraft when the aircraft is taxiing in preparation for take-off:
determining a deflection angle of the elevator, the deflection angle corresponding to a load applied by the aircraft to a nose gear such that said load is within a predetermined load range; and,
controlling an actuator of the elevator so as to apply said deflection angle to the elevator.

6. The method as claimed in claim 5, wherein, with the elevator forming a part of a set of elevators of the aircraft, the step of determining the deflection angle of the elevator comprises the following sub-steps:
estimating a total moment about a pitch axis of the aircraft;
estimating a moment about the pitch axis induced by the elevators of the set of elevators; and
computing the deflection angle of the elevator as a function of the total moment, the moment induced by the elevators of the set of elevators, the load to be applied to the nose gear, and a distance between a center of gravity of the aircraft and the nose gear.

7. The method as claimed in claim 5, further comprising a step of:
acquiring a current speed value of the aircraft,
wherein the steps of determining the deflection angle of the elevator and of controlling the actuator of the elevator so as to apply said deflection angle to the elevator are only implemented when the current speed value is at least equal to a predetermined speed threshold.

8. The method as claimed in claim 5, wherein the step of determining the deflection angle of the elevator comprises a sub-step of limiting said deflection angle of the elevator between a minimum deflection angle value and a maximum deflection angle value.

9. An aircraft comprising:
the flight control system as claimed in claim 1.
